(19) United States
(12) Patent Application Publication
(10) Pub. No.: US 2019/0112722 A1
(43) Pub. Date: Apr. 18, 2019

(54) ELECTRODEPOSITION OF HIGH DAMPING MAGNETIC ALLOYS

(71) Applicant: Seagate Technology LLC, Cupertino, CA (US)

(72) Inventors: Jie Gong, Eden Prairie, MN (US); Steven C. Riemer, Minneapolis, MN (US); John A. Rice, Long Lake, MN (US); Hilton Erskine, Hillman, MN (US); Michael C. Kautzky, Eagan, MN (US)

(21) Appl. No.: 15/785,698

(22) Filed: Oct. 17, 2017

(51) Int. Cl. C25D 5/18; H01F 1/147; G11B 5/706; C25D 7/00; C25D 7/12; C25D 3/56; C22C 30/00

(52) U.S. Cl. CPC C25D 5/18; H01F 1/14708; G11B 5/70615; C22C 2202/02; C25D 7/12; C25D 3/56; C22C 30/00; C25D 7/001

(57) ABSTRACT

A method includes immersing a wafer in an electrolyte including a plurality of compounds having elements of a high damping magnetic alloy with very low impurity and small uniform grain size. The method also includes applying a pulsed current with a certain range of duty cycle and pulse length to the wafer when the wafer is immersed in an electrolyte. The wafer is removed from the electrolyte when a layer of the high damping magnetic alloy is formed on the wafer.

### BACKGROUND

Data storage devices use magnetic recording heads to read and/or write data on magnetic storage media, such as data storage discs. Magnetic recording heads typically include inductive write elements to record data on the storage media. An inductive write element or transducer may include a main pole having a pole tip and one or more return poles. Current is supplied to write coils to induce a flux path in the main pole to record data on one or more magnetic storage layers of the media.

With ever-increasing levels of recording density in disc drives, the write element needs to have correspondingly better data-recording capabilities and needs to be substantially reliable. In general, as areal recording densities for storage discs increase, technological advances and changes to various components of the disc drives are needed.

### SUMMARY

Various embodiments of the disclosure generally relate to including high damping materials with low impurity levels in elements (for example, shields and/or poles) of recording heads to improve reliability of the recording heads. In different embodiments, electrodeposition or electroplating may be used to form the elements with the high damping materials.

In one embodiment, a method is provided. The method includes immersing a wafer in an electrolyte including a plurality of compounds having elements of a high damping magnetic alloy. The method also includes applying a pulsed current to the wafer when the wafer is immersed in an electrolyte. The wafer is removed from the electrolyte when a layer of the high damping magnetic alloy is formed on the wafer.

Other features and benefits that characterize embodiments of the disclosure will be apparent upon reading the following detailed description and review of the associated drawings.

### BRIEF DESCRIPTION OF THE DRAWINGS

FIG. 1A illustrates an embodiment of a data storage device in which embodiments of the present application can be used.

FIG. 1B is a schematic illustration of a head including one or more transducer elements above a magnetic recording medium.

FIG. 2A depicts a bearing surface view of an example perpendicular magnetic recording (PMR) transducer.

FIG. 2B depicts a side view of the PMR transducer of FIG. 2A.

FIG. 2C depicts a perspective view of a portion of the PMR transducer of FIGS. 2A and 2B.

FIG. 3A depicts a bearing surface view of another example PMR transducer.

FIG. 3B depicts a side view of the PMR transducer of FIG. 3A.

FIG. 4 is a diagrammatic illustration of an electroplating system in accordance with one embodiment.

FIGS. 5A-5C illustrate process steps for forming a portion of a PMR transducer of the type shown in FIGS. 2A and 2B using the electroplating system of FIG. 4.

FIG. 6 is a flow diagram of a method embodiment.

FIGS. 7 and 8 are graphs showing an impact of a duty cycle on properties of NiFeX.

FIGS. 9 and 10 are graphs showing an impact of a pulse on time on properties of NiFeX.

FIGS. 11-15 are graphs that plot results obtained for NiFeRe films formed by electrodeposition.

FIGS. 16A, 16B and 16C show topographical images of films formed by electrodeposition.

FIG. 17 is a graph showing plots related to corrosion properties of films.

### DETAILED DESCRIPTION OF ILLUSTRATIVE EMBODIMENTS

Embodiments of the disclosure generally relate to including high damping materials in elements (for example, shields and/or poles) of recording heads to improve reliability of the recording heads. In different embodiments, electrodeposition or electroplating may be used to form the elements with the high damping materials. However, prior to providing additional details regarding the different embodiments, a description of an illustrative operating environment is provided below.

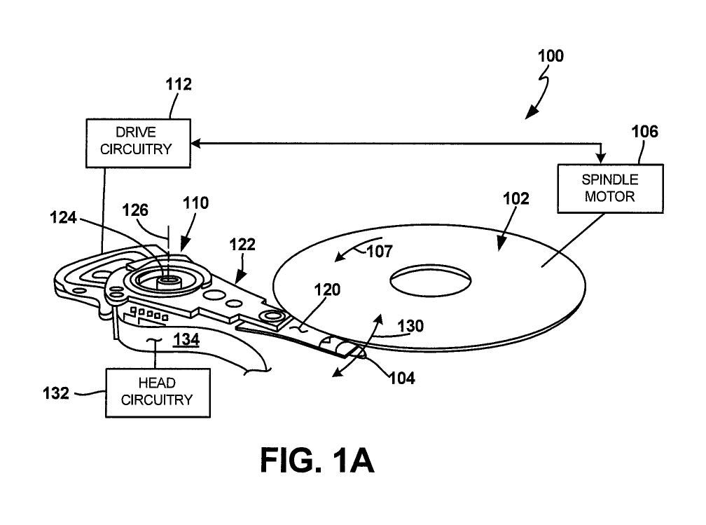

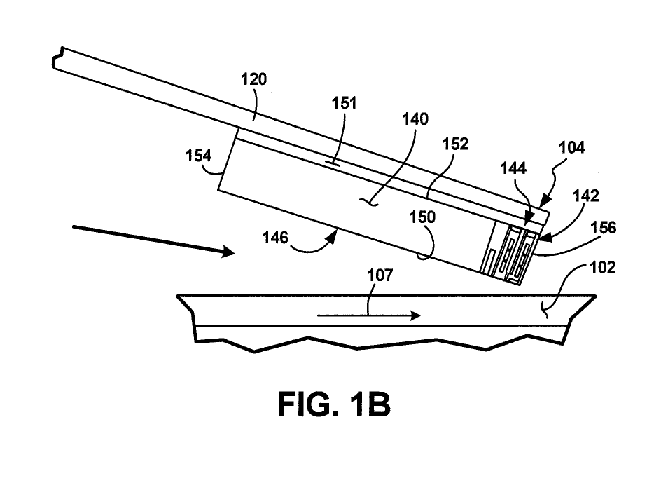

FIG. 1A shows an illustrative operating environment in which certain write head embodiments formed by methods disclosed herein may be incorporated. The operating environment shown in FIG. 1A is for illustration purposes only. Embodiments of the present disclosure are not limited to any particular operating environment such as the operating environment shown in FIG. 1A. Embodiments of the present disclosure are illustratively practiced within any number of different types of operating environments.

It should be noted that the same reference numerals are used in different figures for same or similar elements. It should also be understood that the terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

FIG. 1A is a schematic illustration of a data storage device 100 including a data storage medium and a head for reading data from and/or writing data to the data storage medium. As shown in FIG. 1A, the data storage device 100 includes a data storage medium 102 and a head 104. The head 104 including one or more transducer elements (not shown in FIG. 1A) is positioned above the data storage medium 102 to read data from and/or write data to the data storage medium 102. In the embodiment shown, the data storage medium 102 is a rotatable disc or other magnetic storage medium that includes a magnetic storage layer or layers. For read and write operations, a spindle motor 106 (illustrated schematically) rotates the medium 102 as illustrated by arrow 107 and an actuator mechanism 110 positions the head 104 relative to data tracks on the rotating medium 102. Both the spindle motor 106 and actuator mechanism 110 are connected to and operated through drive circuitry 112 (schematically shown). The head 104 is coupled to the actuator mechanism 110 through a suspension assembly which includes a load beam 120 connected to an actuator arm 122 of the mechanism 110 for example through a swage connection.

The one or more transducer elements of the head 104 are coupled to head circuitry 132 through flex circuit 134 to encode and/or decode data. Although FIG. 1A illustrates a single load beam 120 coupled to the actuator mechanism 110, additional load beams 120 and heads 104 can be coupled to the actuator mechanism 110 to read data from or write data to multiple discs of a disc stack. The actuator mechanism 110 is rotationally coupled to a frame or deck (not shown) through a bearing 124 to rotate about axis 126. Rotation of the actuator mechanism 110 moves the head 104 in a cross track direction as illustrated by arrow 130.

FIG. 1B is a detailed illustration (side view) of the head 104 above the medium 102. The one or more transducer elements on the head 104 are fabricated on a slider 140 to form a transducer portion 142 of the head 104. The transducer portion 142 shown includes write elements encapsulated in an insulating structure to form a write assembly 144 of the head. As shown, the head 104 includes a bearing surface (for example, and air bearing surface (ABS)) 146 along a bottom surface 150 of the head or slider facing the medium 102. The head 104 is coupled to the load beam 120 through a gimbal spring 151 coupled to a top surface 152 of the head or slider 140 facing away from the medium 102. The medium 102 can be a continuous storage medium, a discrete track medium, a bit patterned medium or other magnetic storage medium including one or more magnetic recording layers.

During operation, rotation of the medium or disc 102 creates an air flow in direction 107 as shown in FIG. 1B along the air bearing surface 146 of the slider 140 from a leading edge 154 to the trailing edge 156 of the slider 140 or head 104. Air flow along the air bearing surface 146 creates a pressure profile to support the head 104 and slider 140 above the medium 102 for read and/or write operations. As shown, the transducer portion 142 is formed at or near the trailing edge 156 of the slider 140.

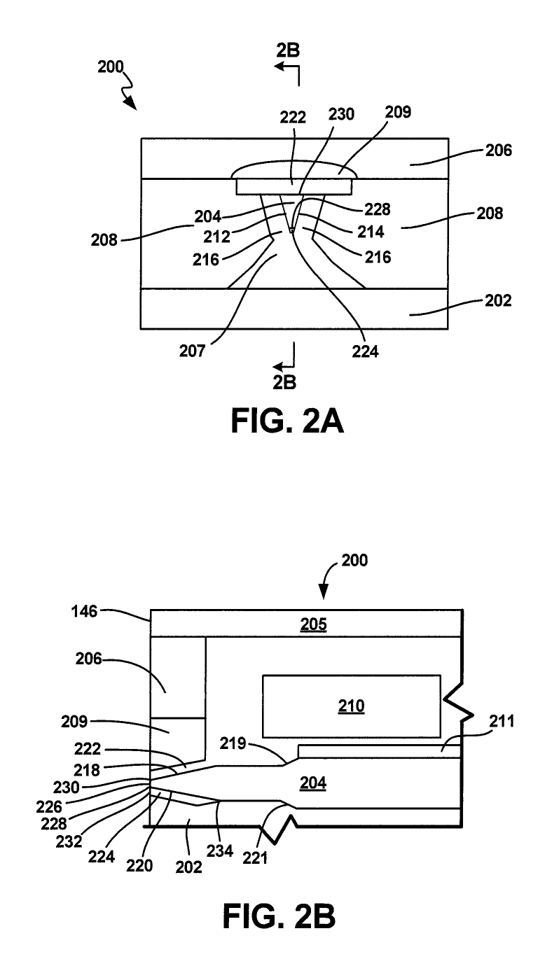

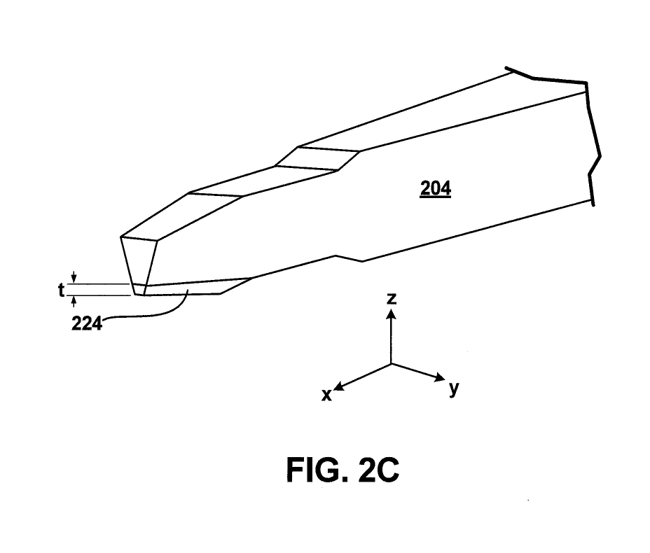

As indicated earlier, the ever-increasing levels of recording density in data storage devices such as disc drives has caused a push for better write performance which, in turn, has resulted in certain write head designs that may have reliability problems. To address such problems, a high damping material may be employed in shields and/or a pole of a write head. A write head that includes a high damping material in its shields and/or poles is described below in connection with FIGS. 2A-2C.

FIGS. 2A, 2B and 2C depict air bearing surface, side and perspective views, respectively, of a perpendicular magnetic recording (PMR) transducer or head 200 in accordance with one embodiment. The PMR transducer 200 may be a part of a merged head including the write transducer 200 and a read transducer (not shown). Alternatively, the magnetic recording head may be a write head only including the write transducer 200. The PMR transducer elements shown in FIGS. 2A, 2B and 2C are illustratively included in a recording head such as recording head 104 of FIGS. 1A and 1B.

The write transducer 200 includes an under-layer/substrate 202, a main pole 204, at least one return pole 205, a trailing edge shield 206 and side shields 208. The under-layer 202 may include multiple structures which are under the pole 204. The write transducer 200 may also include other components including but not limited to coils (denoted by reference numeral 210 in FIG. 2B) for energizing the main pole 204, and a yoke 211.

The main pole 204 resides over under-layer 202 and includes sidewalls 212 and 214. Sidewalls 212 and 214 are separated from the side shields 208 by non-magnetic side shield gaps (SSGs) 216. The top (trailing) surface of the main pole 204 also has a beveled portion 218. The bottom (leading) surface of the main pole 204 may further include a leading surface bevel 220. Additional beveled portions 219 and 221 may also be present behind the bearing surface 146. A trailing shield gap (TSG) 222 is formed between the main pole 204 and the trailing edge shield 206.

The write head 200 further includes a high damping magnetic alloy layer 224 attached to the leading surface bevel 220. Further, in some example, side shields 208 may include a high damping material. In still other examples, portions of trailing edge shield 206 or entire trailing edge 206 may include a high damping material. The high damping magnetic alloy layer 224 includes a magnetic material (e.g., Permalloy (NiFe), Fe, FeCo) infused with a small percentage of a transition 5d metal such as rhenium (Re), osmium (Os), iridium (Jr), etc. For example, the high damping material layer may be NiFeX, with X being the transition 5d metal having a content between about 1 and about 15 atomic (at) percent (%). A thickness (t in FIG. 2C) of high damping material layer 224 may be between about 10 nanometers (nm) and about 50 nm. In some cases, a thickness of high damping material layer 224 may be more than 50 nm. Shields 208 may similarly include a magnetic material infused with a small percentage of a transition 5d metal such as rhenium, osmium, iridium, etc. Such writer shields respond to flux leakage from the write pole 204 in a gentler manner, thereby improving the erasure fields by cutting-out peaks. In some examples, shields 208 may be laminated structures with at least one layer of the laminated structure including a small percentage of a transition 5d metal such as rhenium, osmium, iridium, etc., and at least one other layer not including any transition 5d metal. Also, in certain examples, entire trailing edge shield 206 or a portion of trailing edge shield 206 (e.g., portions other than 209) may include a magnetic material infused with a small percentage of a transition 5d metal such as rhenium, osmium, iridium, etc.

As can be seen in FIGS. 2A and 2B, at the bearing surface 146, the main pole 204 has a trapezoid shape with a front surface 226 that forms a portion of the bearing surface 146. The front surface 226 has a leading edge 228 and a trailing edge 230. In one example, the high damping material layer 224 has a front end 232 that is attached to the main pole 204 at the leading edge 228. As can be seen in FIG. 2B, the high damping material layer 224 extends from the front end at the leading edge 228 to a rear end 234 of the leading surface bevel 220. It should be noted that, in different examples, the high damping material may or may not cover the entire leading surface bevel 220.

In the examples described above in connection with FIGS. 2A and 2B, side shields 208 are split (e.g., side shields 208 are not connected below the leading edge or bottom edge 228 of the main pole 204). As can be seen in FIGS. 2A and 2B, the side shields are split by layer 207, which may be a non-magnetic or insulating material.

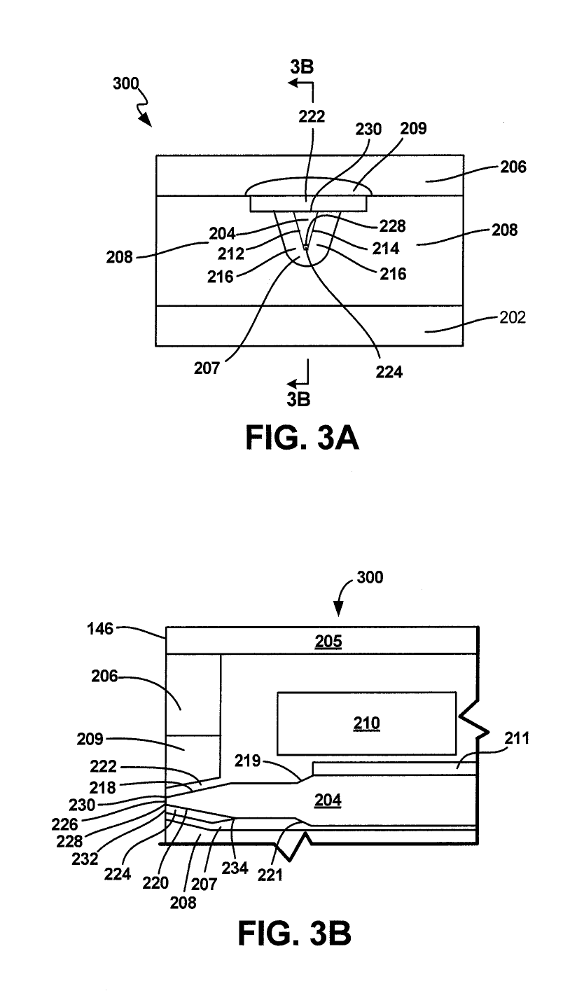

FIGS. 3A and 3B depict air bearing surface and side views, respectively, of a perpendicular magnetic recording (PMR) transducer or head 300 that has a wrap-around shield configuration in accordance with another example. As can be seen in FIG. 3A, side shields 208 are connected below the leading edge or bottom edge 228 of the main pole 204. As in the case of the write head 200 (of FIGS. 2A and 2B), write head 300 may include a high damping material layer 224 attached to the leading surface bevel 220. Further, in some examples, connected side shields 208 of write head 300 may include a high damping material. In still other examples, entire trailing edge shield 206 or a portion of trailing edge shield 206 (e.g., portions other than 209) may include a high damping material.

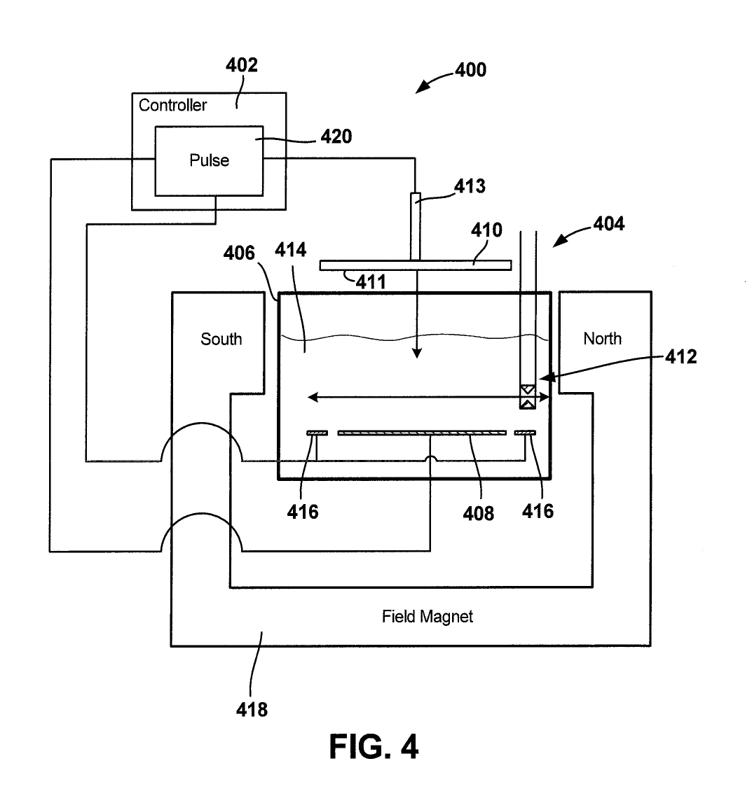

As in the case of the write head 200 (of FIGS. 2A and 2B), in write head 300, the high damping material layer 224 may extend from the front end at the leading edge 228 to a rear end 234 of the leading surface bevel 220. In different examples, the high damping material may or may not cover the entire leading surface bevel 220. As noted above, in different embodiments, electrodeposition or electroplating may be used to form the elements with the high damping materials. One such electrodeposition or electroplating embodiment is described below in connection with FIG. 4.

FIG. 4 is a diagrammatic illustration of an electroplating system 400 in accordance with one embodiment. Electroplating system 400 includes control circuitry 402 and a plaiting tank 404. Plating tank 404 includes a container 406, an anode 408, a cathode 410, a paddle assembly 412, a solution or electrolyte 414, cathodic thief element elements 416 and a magnet 418.

Container 406 may be made of any suitable material, which may not be electrically conductive (e.g., glass or plastic). Anode 408 is positioned within the container 406 and may be located relatively close to a bottom of the container 406 as shown in FIG. 4. Anode 408 may be formed of a wire mesh or a combination of a plate and a wire mesh. The plate and/or wire mesh may be formed of platinum (Pt) and/or Nickel (Ni).

Cathode 410 includes an electrically conductive wafer on which a high damping magnetic alloy is to be deposited. As can be seen in FIG. 4, the wafer 410 has an exposed surface 411 on which the high damping magnetic alloy is to be deposited. Surface 411 may include a photoresist pattern if only portions of surface 411 are to be deposited with the high damping magnetic alloy. If no photoresist pattern is included on surface 411, the high damping magnetic alloy will be deposited on the entire exposed surface 411. In some embodiments, the wafer includes an electrically conductive substrate and an electrically conductive seed layer (e.g., a NiFe seed layer) with surface 411 being an exposed surface of the electrically conductive seed layer. The cathode 410 may be releasably coupled to, and supported by, an arm 413 which, with the help of control circuitry 402, immerses the cathode 410 into the container 406 for deposition of the high damping magnetic alloy. In some embodiments, manual adjustments to a position of the arm 413 may be carried out in order to immerse the cathode 410 into the solution 414. Once the deposition process is complete, the wafer 410 with the high damping magnetic layer deposited thereon may be removed from the solution 414 by the arm 413 under the control of control circuit 402 and/or by manual adjustments of the position of the arm 413. The removed wafer 410 may then be detached from the arm 413. In should be noted that positioning the cathode 410 above the anode 408 within container 406 provides certain advantages. For example, if a high damping magnetic alloy layer is to be deposited on a number of wafers, positioning the cathode 410 in a manner shown in FIG. 4 allows for relatively rapidly attaching a first wafer to the arm 413, immersing the first wafer into the electrolyte substantially immediately after its attachment to the arm 413, carrying out the deposition of the high damping magnetic alloy layer, removing and detaching the first wafer, and then processing the next wafer in a similar manner. Further, bubbles that may be formed on the cathode 410 during electrodeposition move in an upward direction and may escape from the electrolyte 414 instead of attaching to the cathode. In spite of different advantages with the cathode 410 positioned above the anode 408, in certain embodiments, the positions of the cathode 410 and the anode 408 may be reversed.

In general, solution/bath/electrolyte 414 within container 406 may include several compounds that are suitable for deposition of the high damping magnetic alloy. Examples of compounds that may be used to deposit a NiFeX high damping magnetic layer on the wafer 410 are included in Table 1 below.

TABLE 1

| COMPOUND | RANGE/VALUE |
|---|---|
| H₃BO₃ | about 0.15 to about 0.6 moles/liter |
| Ni²⁺ | about 0.18 to about 0.36 moles/liter |
| Organic additives | about 0.8 grams/liter |
| sodium lauryl sulfate or | about 0.1 grams/liter |
| sodium dodecyl sulfate | |
| Fe²⁺ | about 0.015 to about 0.03 moles/liter |
| X elements (e.g., Re, Ir, Os) | about 0.005-0.4 millimolar |
| Fe³⁺ | less than about 0.01 gram/liter |
| pH | about 2 to about 3 |

Sources of Ni²⁺ and Fe²⁺ may include chlorides, sulfates and perchlorates, and X elements may be any salt including that element and that is dissolvable in an aqueous solution. Solution or bath 414 may substantially constantly be stirred by reciprocating mixing element or paddle 412, which travels back and forth (as shown by bidirectional arrow 415) below surface 411 of the wafer 410. Paddle 412 is typically in close proximity with surface 11 and provides the agitation of the bath 414 with minimum turbulence.

In the embodiment if FIG. 4, controller 402 includes pulse current supply circuitry 420, which is electrically coupled to anode 408, to cathode/wafer 410 and to cathodic thief element elements 416. Cathodic thief element elements 416 may be in a substantially same plane as the anode 408 and are included to steal current away from edges of the wafer 410, and thereby help ensure that the deposition on the wafer 410 is uniform. It should be noted that, in some embodiments, pulse current supply circuitry 420 may be separate from controller 402. During operation, to supply a pulse current, circuitry 420 may toggle the current between high and low values (e.g., circuitry 420 may be turned on and off for predetermined intervals of time) to provide suitable deposition conditions. Table 2 below includes examples of depositions conditions.

TABLE 2

| CONDITION | RANGE/VALUE |
|---|---|
| time that current supply circuitry is on (t_on) | 10-400 milliseconds |
| time that current supply circuitry is off (t_off) | 20-1000 milliseconds |
| pulse peak current density (I) | about 15 milliamperes/ |
| | square centimeter to |
| | about 45 milliamperes/ |
| | square centimeter |
| rate of formation of the high | about 60 nanometers/ |
| damping magnetic alloy layer | minute |

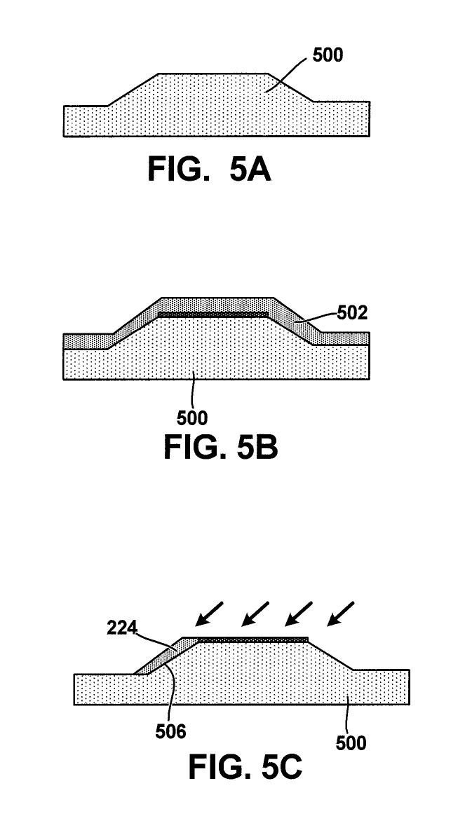

An electrolyte provided as show in Table 1 and the conditions shown in Table 2 may be used in the apparatus of FIG. 4 to form (Ni₇₀₋₁₅Fe₃₀₋₈₅)₈₇₋₉₉X₁₋₁₃ with the following properties:
Stress between about 150 to about 250 mega pascals (MPa).
Saturation magnetization (Bs) between about 0 to about 1.6 Tesla.
Easy axis coercivity (Hce) between about 2 to about 4 Oersted.
Hard axis coercivity (Hch) between about 0 to about 0.4 Oersted.
Damping constant: between about 0.005 (for 0 doping) to about 0.03 (for 10 (at) % doping).
Uniformity between about 6 to about 8%, where uniformity=range (e.g., maximum−minimum)/mean.
   An example that illustrates formation of a high damping magnetic alloy layer in accordance with the above-described electrodeposition process is provided below in connection with FIGS. 5A through 5C.

FIG. 5A illustrates a side view of an under-layer 500 on which a main pole (such as 204 of FIGS. 2A, 2B and 2C) with a high damping magnetic alloy layer (such as 224 of FIGS. 2A, 2B and 2C) is to be formed. The high damping magnetic alloy layer that forms part of the main pole may be formed by an electrodeposition process of the type described above in connection with FIG. 4. It should be noted that under-layer 500 illustrated in FIG. 5A is a partial structure of a single write head, which, in turn, is part of a wafer that includes a plurality of write head structures.

In accordance with one embodiment, the wafer including under-layer 500 is attached to arm 413 (of FIG. 4), immersed in solution 414 (of FIG. 4) and supplied with a pulsed current in a manner described above in connection with FIG. 4. This results in the formation of a high damping magnetic alloy layer 502 on the wafer that includes that under-layer 500 as shown in FIG. 5B. Once layer 502 is formed, the wafer including layers 500 and 502 is removed from the solution 414 (of FIG. 4) and detached from the arm 413 (of FIG. 4).

A material removal operation may then be carried out on layer 502 to leave behind portion 224. FIG. 5C illustrates a side view of a partial write transducer structure formed after the material removal operation (e.g., milling) is carried out on layer 502. As can be seen in FIG. 5C, the milling operation (denoted by reference numeral 504 in FIG. 5C) is conducted at such an angle so that the part 224 of the high damping magnetic alloy layer 502 is protected from the milling operation. For example, the milling operation is conducted at an angle that is lower (as compared to the horizontal surface) compared to an angle of a bevel 506 (again, as compared to the horizontal surface). The milling operation 504 mills away most of the high damping magnetic alloy layer 502, except for the material that is protected due to the angle of the bevel 506. After formation of high damping magnetic alloy layer 224, layer 204 (of FIGS. 2A, 2B and 2C) is formed on the structure shown in FIG. 5C using any suitable technique. It should be noted that the embodiment described in connection with FIGS. 5A, 5B and 5C involves sheet film deposition of layer 502 by an electrodeposition process. In an alternate embodiment, a photoresist pattern may be formed on under-layer 500 prior to the electrodeposition process. Electrodeposition may then be carried out on the patterned wafer to provide feature 224 without using the material removal process shown in FIG. 5C.

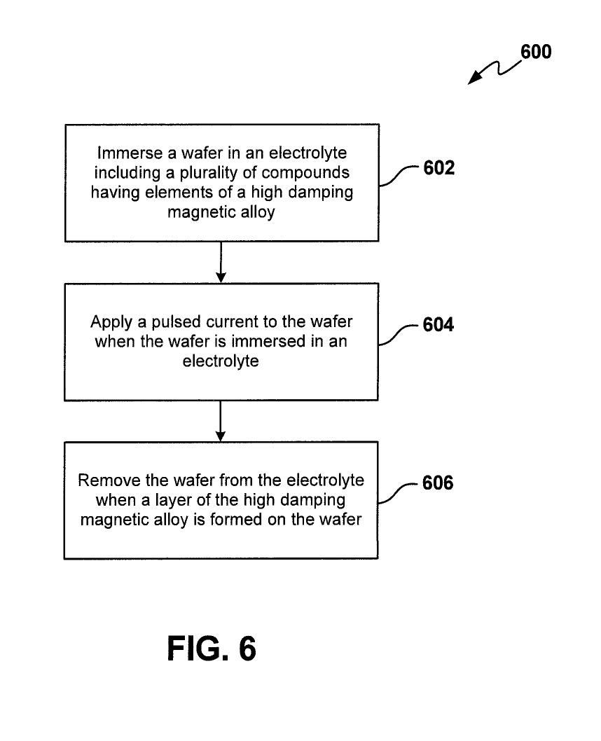

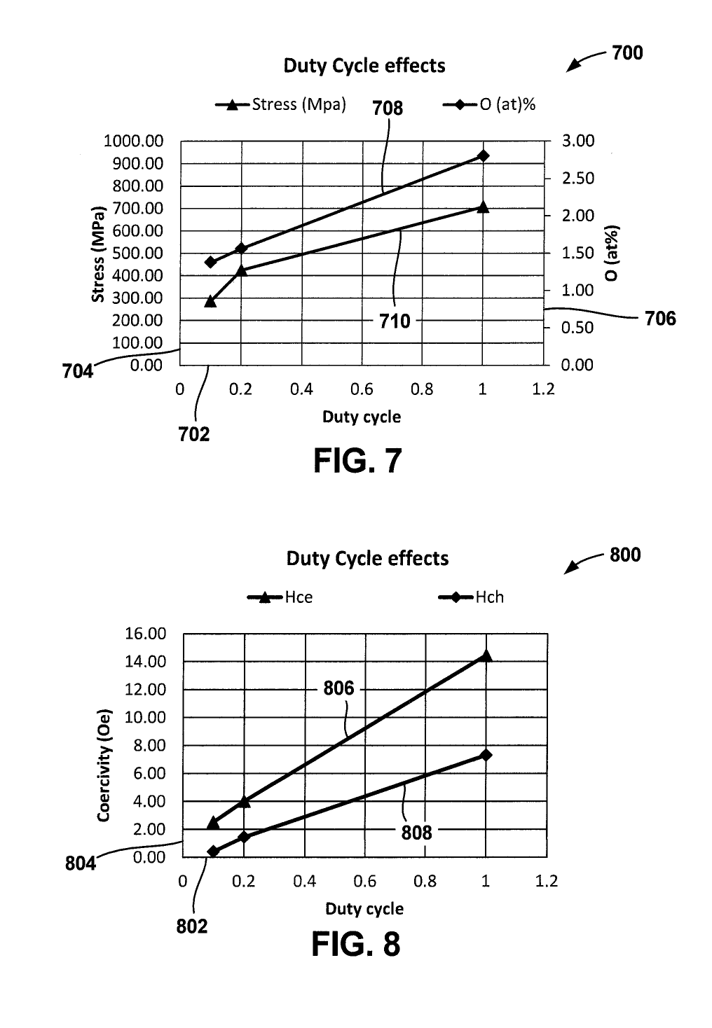

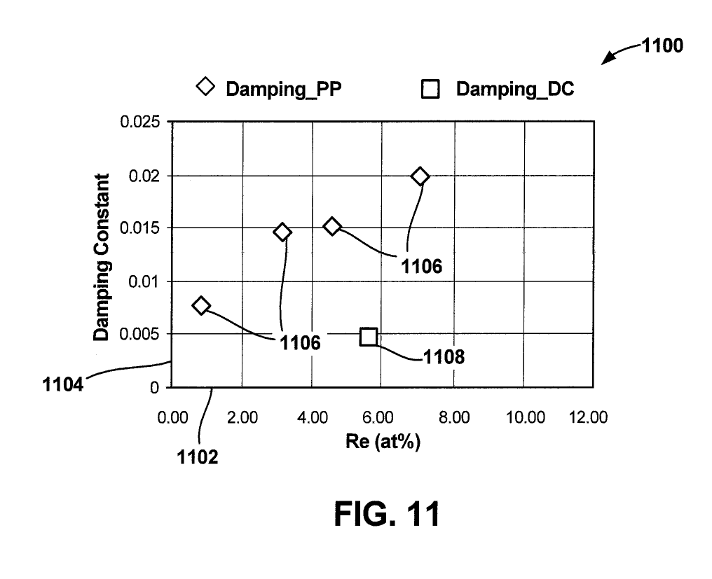

As noted above, the inclusion of high damping magnetic alloy layers in poles and/or shields of write heads provide reliability improvements. Further, a manner in which electrodeposition is carried out has an impact on the quality of the deposited high damping magnetic alloy layer. For example, electrodeposition carried out in a manner described above using pulsed currents has advantages over electrodeposition carried out using direct current (DC). A general electrodeposition method using a pulsed current is described below in connection with FIG. 6. That description is followed by a description of certain impactful factors of pulse plating parameters in connection with FIGS. 7-10. Thereafter, comparison results for pulsed current versus DC electrodeposition are described further below in connection with FIGS. 11 through 17.

FIG. 6 is a flow diagram 600 of a method embodiment. The method includes, at step 602, immersing a wafer in an electrolyte including a plurality compounds having elements of a high damping magnetic alloy. At step 604, a pulsed current is applied to the wafer when the wafer is immersed in an electrolyte. At step 606, the wafer is removed from the electrolyte when a layer of the high damping magnetic alloy is formed on the wafer.

A pulse plating duty cycle (defined by t_on/(t_on+t_off) may have an impact on obtaining NiFeX films with a low impurity (e.g., oxygen (O)) level, which is important for favorable material properties. A low duty cycle may be employed for obtaining NiFeX films with superior properties. FIG. 7 is a graph 700 that shows the effects of duty cycle on oxygen content and stress. In FIG. 7, horizontal axis 702 represents duty cycle values, left vertical axis 704 represents stress in MPa and right vertical axis represents at % of O. Plot 708 connects O content values in NiFeX obtained with different duty cycle values. Plot 710 connects stress values for NiFeX over different duty cycle values. As can be seen in FIG. 7, a low duty cycle results in both low O content and low stress in a NiFeX film. The lower the O and stress, the better the properties of the NiFeX film.

FIG. 8 is a graph 800 that shows the effects of duty cycle on magnetic coercivity. In FIG. 8, horizontal axis 802 represents duty cycle values and vertical axis 804 represents coercivity in Oe. Plot 806 connects Hce values over different duty cycle values. Plot 810 connects Hch values over different duty cycle values. As can be seen in FIG. 8, low duty cycle values result in low Hce and Hch values, which is desirable.

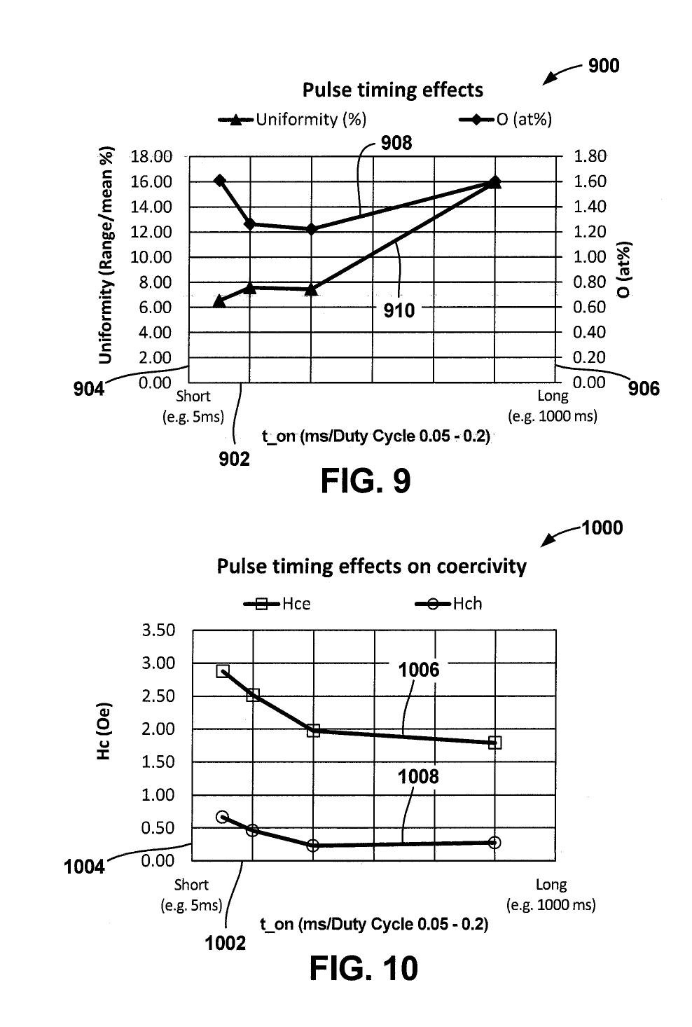

To obtain NiFeX with high damping and superior magnetic properties, the pulse timing (pulse on time (t_on)) is another factor to control. FIG. 9 is a graph 900 that shows the effects of t_on on impurity O and on film uniformity. In FIG. 9, horizontal axis 902 represents t_on in milliseconds (ms)/duty cycle of 0.05 to 0.2, first vertical axis 904 represents uniformity in range/mean %, and second vertical axis 906 represents at % of O. Plot 908 connects uniformity values for NiFeX over different ton values. Plot 910 connects O content values in NiFeX obtained with different t_on values. As can be seen in FIG. 9, shows that with the same duty cycle (t_on/(t_on+t_off)), the impurity content (e.g., O content) is minimum when t_on is between 20-40 ms. Also, plot 910 shows that film uniformity is optimal when t_on is between 20-40 ms.

FIG. 10 is a graph 1000 that shows the effects of t_on on magnetic coercivity. In FIG. 10, horizontal axis 1002 represents t_on in ms/duty cycle of 0.05 to 0.2 and vertical axis 1004 represents coercivity in Oe. Plot 1006 connects Hce values over different t_on values. Plot 1008 connects Hch values over different t_on values. As can be seen in FIG. 10, Hce and Hch are in an optimal range (e.g., low) when t_on is between 20-40 ms.

The following table (Table 3) shows that, by using the bath chemistry of Table 1 and the pulse plating parameters (e.g., t_on and t_off times provided above in connection with FIGS. 7-10), NiFeX with a very low impurity level may be obtained. With the low impurity levels shown in Table 3 below, superior physical and magnetic properties, including a high damping constant, may be achieved.

TABLE 3

| O | S | C | Cl | F |
|---|---|---|---|---|
| (at %) | (at %) | (at %) | (at %) | (at %) |
| <about | <about | <about | <about | <about |
| 0.102 | 0.172 | 0.11 | 0.0044 | 1.60E−05 |

In Table 3, Ni, Fe and X are not shown. The values included in Table 3 are obtained from secondary-ion mass spectrometry (SIMS).

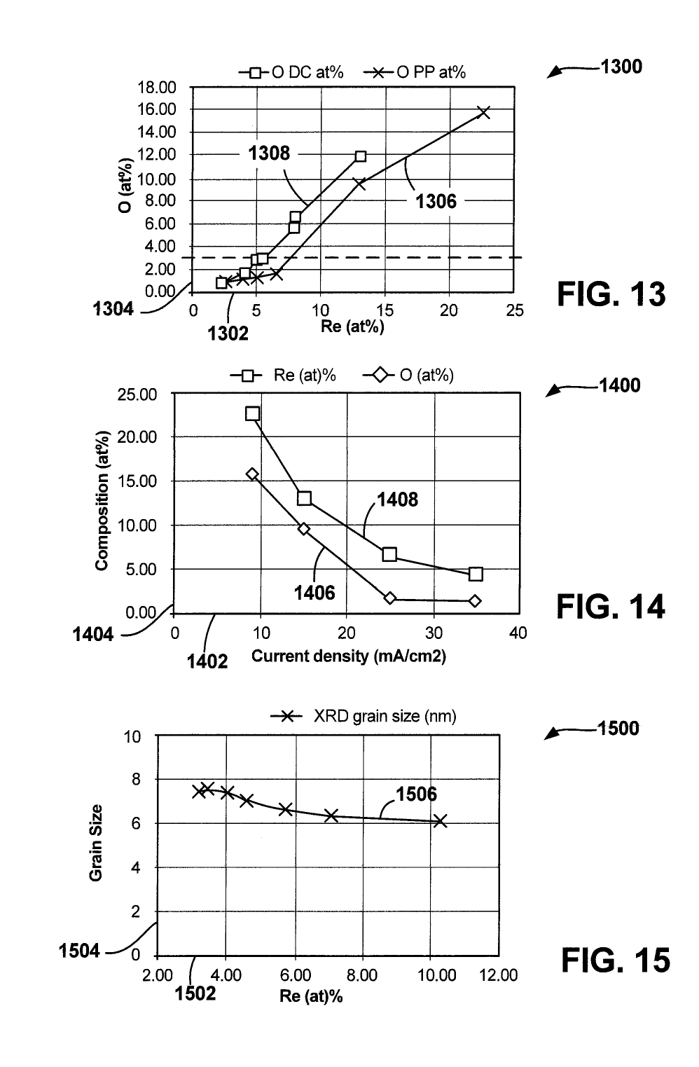

As will be described below in connection with FIGS. 11-18, NiFeX (e.g., NiFeRe) formed by electrodeposition using pulsed current (for example, with t_on and t_off times provided above in connection with FIGS. 7-10) provides substantial and unexpected improvements relative to NiFeX (e.g., NiFeRe) formed by electrodeposition using direct current. For example, damping constant values for NiFeX (e.g., NiFeRe) are substantially higher when pulsed current electrodeposition is used (for example, with t_on and t_off times provided above in connection with FIGS. 7-10) instead of direct current electrodeposition for a similar Re doping level. Also, as indicated in Table 3 and FIG. 13, impurity levels in NiFeX (e.g., NiFeRe) are substantially and unexpectedly low when pulsed current electrodeposition is used (for example, with t_on and t_off times provided above in connection with FIGS. 7-10). Pulse plating with t_on and t_off times provided above in connection with FIGS. 7-10 was employed in an attempt to improve magnetic properties (e.g., improve coercivity) of NiFeX (e.g., NiFeRe) relative to magnetic properties of NiFeX (e.g., NiFeRe) formed by electrodeposition using direct current. However, in addition to providing an improvement in magnetic properties, the pulse plating unexpectedly fundamentally changed the microstructure of NiFeX by producing fine and homogeneous grains in contrast with relatively large crystalline grains of a NiFeX (e.g., NiFeRe) film obtained using direct current deposition. This was accompanied by an unexpected improvement in a damping constant value (e.g., doubling of the damping constant value) as indicated above at a low level of doping concentration of about 3 (at) % as shown in FIG. 11. Thus, the improvements in magnetic properties that one of ordinary skill in the art may have expected were accompanied by the above-noted unexpected results.

FIG. 11 is a graph 1100 that illustrates a comparison of damping constant values obtained for NiFeRe formed by electrodeposition using pulsed current and by electrodeposition using direct current. In FIG. 11, horizontal axis 1102 represents atomic percent (at %) of Re and vertical axis 1104 represents damping constant. Points 1106 are damping constant values obtained for NiFe with different doping levels of Re when a pulsed current is used for the electrodeposition process. Point 1108 is a damping constant value obtained for NiFe doped with Re when DC is used for the electrodeposition process. As can be seen in FIG. 11, damping constant values for NiFeRe are substantially higher when pulsed current electrodeposition is used for a similar Re doping level. Also, as can be seen in FIG. 11, in pulse current deposited NiFeRe, the damping constant increases linearly with Re (at) %. However, DC deposited NiFeRe does not show damping improvement with an increase in Re (at) %.

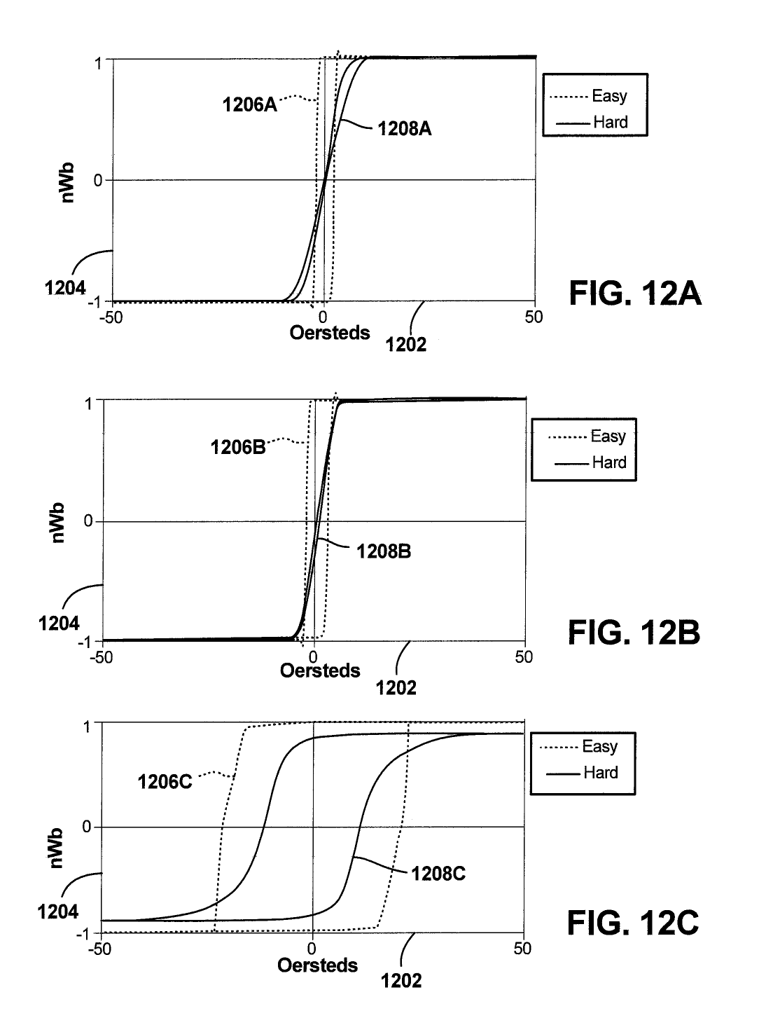

FIGS. 12A, 12B and 12C show magnetic hysteresis loops obtained for Ni₄₅Fe₅₅, Ni₄₅Fe₅₀Re₅ formed by electrodeposition using pulsed current, and Ni₄₅Fe₅₀Re₅ formed by electrodeposition using DC, respectively. In FIGS. 12A, 12B and 12C horizontal axis 1202 represents an applied magnetic field (H) in Oersted (Oe) and a vertical axis 1204 represents normalized flux. In FIGS. 12A, 12B and 12C, loops 1206A, 1206B and 1206C, respectively, are easy axis magnetic loops and loops 1208A, 1208B and 1208 C are respective hard axis loops. As can be seen in FIGS. 12A, 12B and 12C, pulse current deposited Ni₄₅Fe₅₀Re₅ shows superior magnetic properties compared with Ni₄₅Fe₅₅ and DC deposited Ni₄₅Fe₅₀Re₅. For example, hard axis loop 1208B of FIG. 12B includes lines that correspond in shape and substantially overlap over the entire range of magnetic field values, which is not the case with loops 1208A (FIG. 12A) and 1208B (FIG. 12B).

FIG. 13 is a graph 1300 that illustrates a comparison of O content values obtained for NiFeRe formed by electrodeposition using pulsed current and electrodeposition using direct current. In FIG. 13, horizontal axis 1302 represents atomic percent (at %) of Re and vertical axis 904 represents (at) % of O. Plot 1306 connects O content values for NiFe with different doping levels of Re when a pulsed current is used for the electrodeposition process. Plot 1308 connects O content values for NiFe doped with Re when DC is used for the electrodeposition process. As can be seen in FIG. 13, O content generally increases with Re content. In addition, DC deposited NiFeRe contains significantly more O than pulse deposited NiFeRe, which results in high stress and worse magnetics for DC deposited NiFeRe films.

FIG. 14 is a graph 1400 that illustrates variation of Re and O with variation in current density in the deposition of NiFeRe. In FIG. 14, horizontal axis 1402 represents current density (I) in milliamperes/square centimeter (mA/cm²) and vertical axis 1404 represents (at) % of O and Re. Plot 1406 connects O content values in NiFeRe for different current density values, and plot 1408 connects Re values for different current density values. As can be seen in FIG. 14, by changing plating current density, both O and Re content can be varied based on design needs. In addition, both O and Re content decreases with an increase in current density.

FIG. 15 is a graph 1500 that illustrates variation of grain size in pulse current deposited NiFeRe with variation in Re content. In FIG. 15, horizontal axis 1502 represents (at) % of Re and vertical axis 1504 represents grain size in nanometers (nm). Plot 1506 shows that grain size decreases with an increase in Re content.

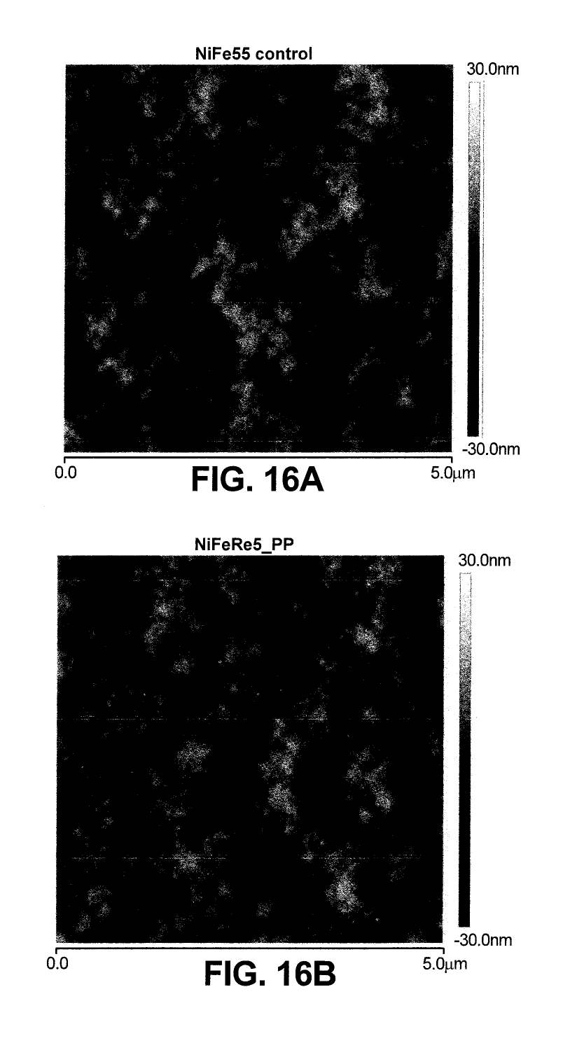

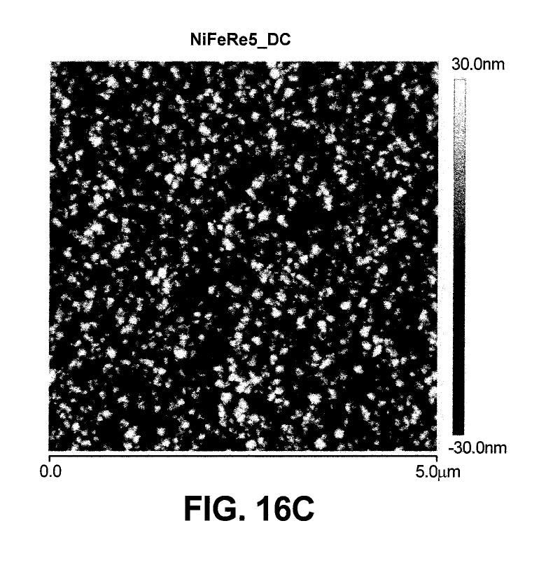

FIGS. 16A, 16B and 16C show topographic images, generated from atomic force microscopy, of Ni₄₅Fe₅₅, Ni₄₅Fe₅₀Re₅ formed by electrodeposition using pulsed current, and Ni₄₅Fe₅₀Re₅ formed by electrodeposition using direct current, respectively. A comparison of images of FIGS. 16A, 16B and 16C show that pulse current deposited NiFeRe has a substantially smooth surface, which is similar to the Ni₄₅Fe₅₅ film surface that serves as the baseline or reference. However, the DC deposited NiFeRe is substantially rough.

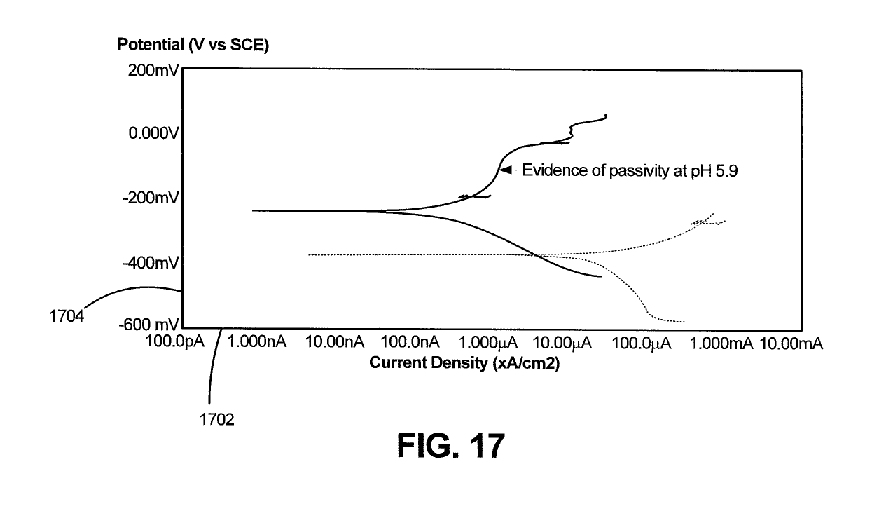

FIG. 17 is a graph showing plots of corrosion properties of Ni₄₁Fe₅₅Re₄ in NaCl 0.1 mole/liter with pH 3 and 5.9, respectively. In FIG. 17, horizontal axis 1702 represents current density (I) in microamperes/square centimeter (uA/cm²) and vertical axis 1704 represents potential (voltage (V) vs saturated calomel electrode (SEC) reference). Table 4 below includes corrosion-related results for Ni₄₁Fe₅₅Re₄, NiFe21.5 weight percent (Wt %) and NiFe55 Wt %.

TABLE 4

| NaCl | pH 3: | pH 3: | pH 5.9: | pH 5.9: |
|---|---|---|---|---|
| 0.1 mole/ | E_{corr} | i_{corr} | E_{corr} | i_{corr} |
| liter | (V vs. SCE) | (uA/cm²) | (V vs. SCE) | (uA/cm²) |
| Ni₄₁Fe₅₅Re₄ | −0.37 | 24 | −0.24 | 0.4 |
| NiFe21.5 | −0.36 | 20 | −0.24 | 0.2 |
| Wt. % | | | | |
| NiFe55 | −0.40 | 20 | −0.25 | 0.4 |
| Wt % | | | | |

The results in Table 4 show that a NiFeRe film has excellent and comparable corrosion properties to NiFe21.5 and NiFe55 reference films. Further, NiFeRe shows passivity in pH 5.9 NaCl corrosion media.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments employ more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method comprising:
immersing a wafer in an electrolyte including a plurality of compounds having elements of a high damping magnetic alloy;
applying a pulsed current to the wafer when the wafer is immersed in an electrolyte; and
removing the wafer from the electrolyte when a layer of the high damping magnetic alloy is formed on the wafer.

2. The method of claim 1 and wherein the plurality of compounds comprises a first compound comprising a first magnetic alloy element and a second compound comprising a second magnetic alloy element and a third compound comprising a 5d transition element.

3. The method of claim 1 and wherein:
the first magnetic alloy element comprises Ni;
the second magnetic alloy element comprises Fe; and
the 5d transition element comprises Re, Jr, Os, Pt, W or Ta.

4. The method of claim 1 and wherein the electrolyte comprises between about 0.15 to about 0.6 moles/liter of H₃BO₃.

5. The method of claim 1 and wherein the electrolyte comprises between about 0.18 to about 0.36 moles/liter of Ni²⁺.

6. The method of claim 1 and wherein the electrolyte comprises between about 0.015 to about 0.03 moles/liter of Fe²⁺.

7. The method of claim 1 and wherein the electrolyte comprises between about 0.005 to about 0.03 millimolar of a 5d transition element.

8. The method of claim 1 and further comprising limiting Fe³⁺ to less than about 0.01 gram/liter in the electrolyte.

9. The method of claim 1 and wherein applying the pulsed current comprises toggling a current between high and low values.

10. The method of claim 9 and wherein the current is maintained at the high value for between about 10 milliseconds and about 400 milliseconds.

11. The method of claim 9 and wherein the current is maintained at the low value for between about 20 milliseconds to about 1000 milliseconds.

12. The method of claim 10 and wherein a density of the current at the high value is between about 15 milliamperes/square centimeter to about 45 milliamperes/square centimeter.

13. The method of claim 1 and wherein a rate of formation of the high damping magnetic alloy layer is about 60 nanometers/minute.

14. An electrolyte comprising:
H₃BO₃ having a concentration in a range of between about 0.15 to about 0.6 moles/liter;
Ni²⁺ having a concentration in a range of between about 0.18 to about 0.36 moles/liter;
Fe²⁺ having a concentration in a range of between about 0.015 to about 0.03 moles/liter;
and
a 5d transition element having a concentration in a range of between about 0.005 to about 0.4 millimolar.

15. The electrolyte of claim 14 and further comprising a pH of about 2 to about 3.

16. The electrolyte of claim 14 and wherein the 5d transition element comprises Re, Ir, Os, Pt, W or Ta.

17. A method comprising:
immersing a wafer to a first depth in an electrolyte including a plurality of compounds having elements of a high damping magnetic alloy, the first depth being less than a second depth at which an anode in positioned in the electrolyte;
applying a pulsed current to the wafer when the wafer is immersed in an electrolyte; and
removing the wafer from the electrolyte when a layer of the high damping magnetic alloy is formed on the wafer.

18. The method of claim 17 and wherein applying the pulsed current comprises toggling a current between high and low values.

19. The method of claim 18 and wherein the current is maintained at the high value for between about 20 milliseconds and about 40 milliseconds.

20. The method of claim 18 and wherein the current is maintained at the low value for between about 200 milliseconds to about 400 milliseconds.
